(19) United States
(12) Patent Application Publication
(10) Pub. No.: US 2026/0112872 A1
(43) Pub. Date: Apr. 23, 2026

(54) Cable Organizer

(71) Applicant: ABB Schweiz AG, Baden (CH)

(72) Inventors: Rick Kukucka, Ann Arbor, MI (US); James M. Baker, Southaven, MI (US); Nolan Landes, Germantown, TN (US); Daniel P. Edwards, Cordova, TN (US)

(73) Assignee: ABB Schweiz AG, Baden (CH)

(21) Appl. No.: 18/924,236

(22) Filed: Oct. 23, 2024

(51) Int. Cl. H02G 3/04; F16L 3/223

(52) U.S. Cl. CPC H02G 3/0456; F16L 3/2235

(57) ABSTRACT

A cable organizer for at least one cable includes: a support structure having a support structure inner periphery and a support structure outer periphery. The support structure has at least one of: at least one first cable accommodation guide disposed at a first distance from the support structure outer periphery, the at least one first cable accommodation guide being open with respect to the support structure outer periphery so as to allow the at least one cable to be disposed in the at least one first cable accommodation guide, and at least one second cable accommodation guide disposed at a second distance from the support structure outer periphery, the second distance being different than the first distance, the at least one second cable accommodation guide being open with respect to the support structure outer periphery via an exterior cable passage guide.

### FIELD

The present application generally relates to a cable organizer for cables.

### BACKGROUND

In general, electrical cables can be used to transmit electricity over long distances. If the electrical cables are high-voltage electrical cables, the amount of heat generated by each cable is significant, so much so that a first individual cable should be physically separated from a second individual cable so as to minimize the generation of heat. Moreover, it may be desirable to use a number of cables to transmit electricity, particularly in the context of solar farms that have many solar panels that generate electricity that needs to be transmitted to a central location (e.g., a battery at the solar farm), wind farms that have many wind turbines that generate electricity that needs to be transmitted to a central location (e.g., a battery at the wind farm), or for smaller cable indoor usages such as data centers.

Existing cable organizers organize multiple cables into a matrix by way of a prior art cable organizer 2, as shown in FIGS. 1-2. For example, it may be possible to organize sixteen cables 4 into a four-by-four matrix or thirty-six cables 4 into a six-by-six matrix, as shown. One or more grounds posts 6 may be provided along a length of the cables 4 so as to electrically ground the cables 4. Furthermore, a first support member 8 (e.g., a weight-bearing, non-conductive support cable) may be provided along a length of the cables to provide support for the weight of the cables W₄. To support the cables 4, one or more support platforms 10 may be provided, each support platform 10 being secured to the ground, and each support platform having a second support member 12 (e.g., a generally vertical metal I-beam) to which at least one of the ground posts 6, first support members 8, and second support members 12 may be fixed, all in an effort to support for the weight of the cables W₄.

The assembly of such prior art cable organizers 2 is tedious, as the rows of the matrix must be assembled row by row, then disassembled row by row for service access to a failed cable below the top row. There is therefore a need to eliminate tedious installation and lower the serviceability time and effort required to organize cables over a long distance.

### SUMMARY

In an embodiment, the present invention provides a cable organizer for at least one cable, the cable organizer comprising: a support structure having a support structure inner periphery and a support structure outer periphery, wherein the support structure has at least one of: at least one first cable accommodation guide disposed at a first distance from the support structure outer periphery, the at least one first cable accommodation guide being open with respect to the support structure outer periphery so as to allow the at least one cable to be disposed in the at least one first cable accommodation guide, and at least one second cable accommodation guide disposed at a second distance from the support structure outer periphery, the second distance being different than the first distance, the at least one second cable accommodation guide being open with respect to the support structure outer periphery via an exterior cable passage guide so as to allow the at least one cable to pass through the exterior cable passage guide and be disposed in the at least one second cable accommodation guide.

In an embodiment, the present invention provides a method of holding at least one cable, the method comprising: providing a cable organizer, the cable organizer comprising a support structure having a support structure inner periphery, a support structure outer periphery, and at least one of: at least one first cable accommodation guide disposed at a first distance from the support structure outer periphery, the at least one first cable accommodation guide being open with respect to the support structure outer periphery, and at least one second cable accommodation guide disposed at a second distance from the support structure outer periphery, the second distance being different than the first distance, the at least one second cable accommodation guide being open with respect to the support structure outer periphery via an exterior cable passage guide; and disposing the at least one cable in at least one of: the at least one first cable accommodation guide, and the at least one second cable accommodation guide by passing the at least one cable through the exterior cable passage guide.

### BRIEF DESCRIPTION OF THE DRAWINGS

FIG. 1 shows a first view of a prior art cable organizer;

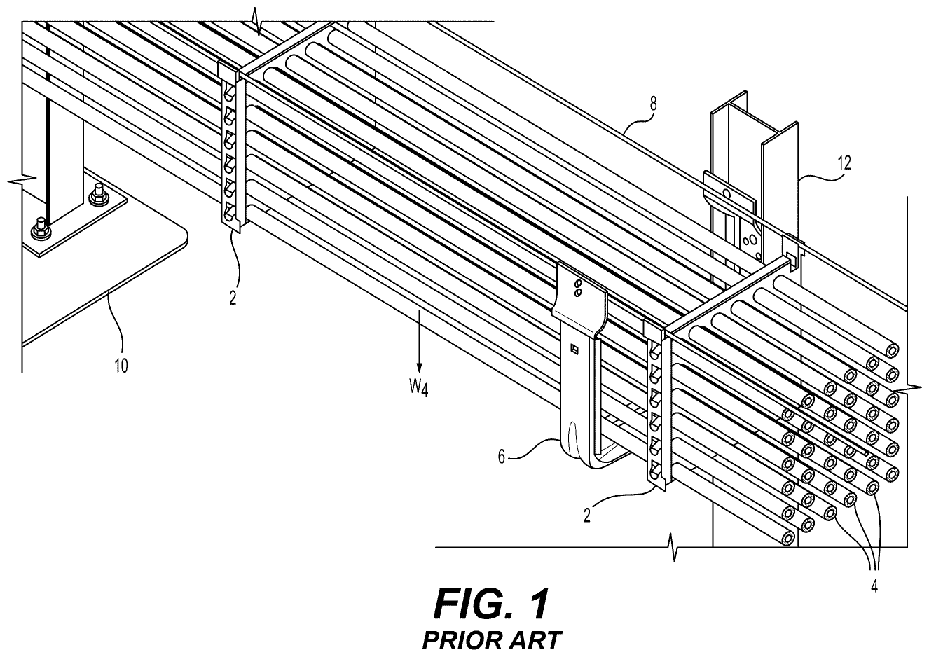

FIG. 2 shows a second view of a prior art cable organizer;

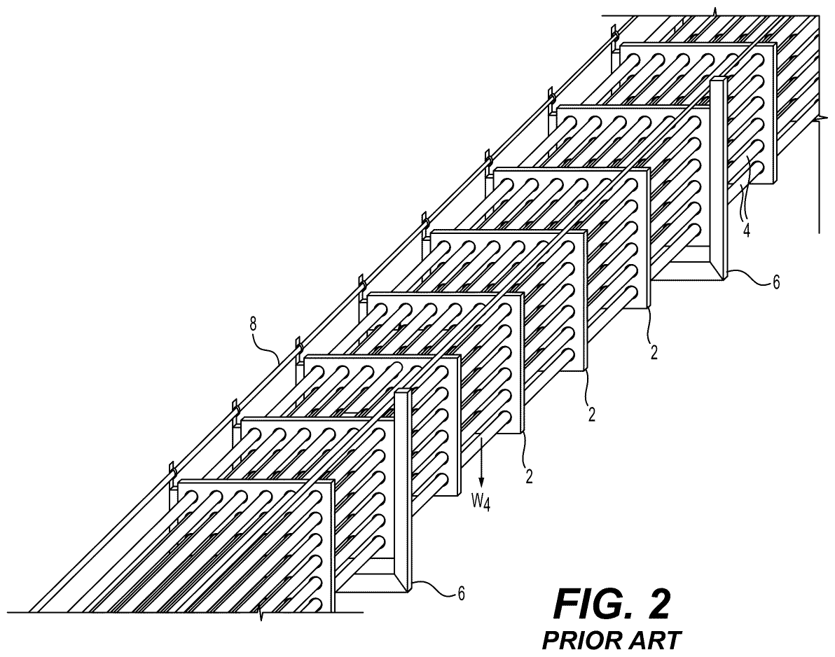

FIG. 3 shows first embodiment of a cable organizer according to the present disclosure;

FIG. 4 shows a second embodiment of cable organizer according to the present disclosure with a locking ring;

FIG. 5 shows a third embodiment of a cable organizer according to the present disclosure;

FIG. 6 shows a fourth embodiment of a cable organizer according to the present disclosure;

FIG. 7 shows a fifth embodiment of a cable organizer according to the present disclosure;

FIG. 8 shows a sixth embodiment of a cable organizer according to the present disclosure;

FIG. 9 shows a seventh embodiment of a cable organizer according to the present disclosure; and

FIG. 10 shows an eighth embodiment of a cable organizer according to the present disclosure.

### DETAILED DESCRIPTION

To overcome the problems associated with the prior art, the present application describes cable organizers that allow easier cable access, to aid servicing failed cables. More particularly, the cable organizers described herein allow direct access to failed cables to facilitate their replacement, and are overall smaller and more serviceable than the prior art, potentially reducing the cross-sectional area of the cable organizer by up to fifty percent. The cable organizers are also scalable to hold a high number of cables (e.g., twenty-four or thirty-six cables), and may include markings to logically identify cable positions over long distances.

The cable organizers described herein may have different shapes. For example, the shapes may be polygon shapes, such as a circle, a quadrilateral, an oval, or an ellipse, as polygon shapes generally have centers, radial directions, and axial directions. However, the cable organizers described herein need not have any particular shape, or a “perfect” polygonal shape. The cable organizers described herein are also scalable to hold different numbers of cables.

The cable organizers described herein may include a support structure that flexes so that cables may be snapped into the cable organizer. The cables may then be held in place, due to the flexing of the support structure and/or an outer lock ring secured to the support structure. The outer lock ring may provide a ground post mount to secure the cable organizer to one or more support members and also electrically ground the cable organizer.

The cable organizers described herein may include an electrically-conductive outer covering on the support structure of the organizer, such as carbon fiber-impregnated ethylene propylene diene monomer (EPDM), to help electrically ground the cable organizer. The covering may be molded over the support structure, which may be made of metal, such as aluminum.

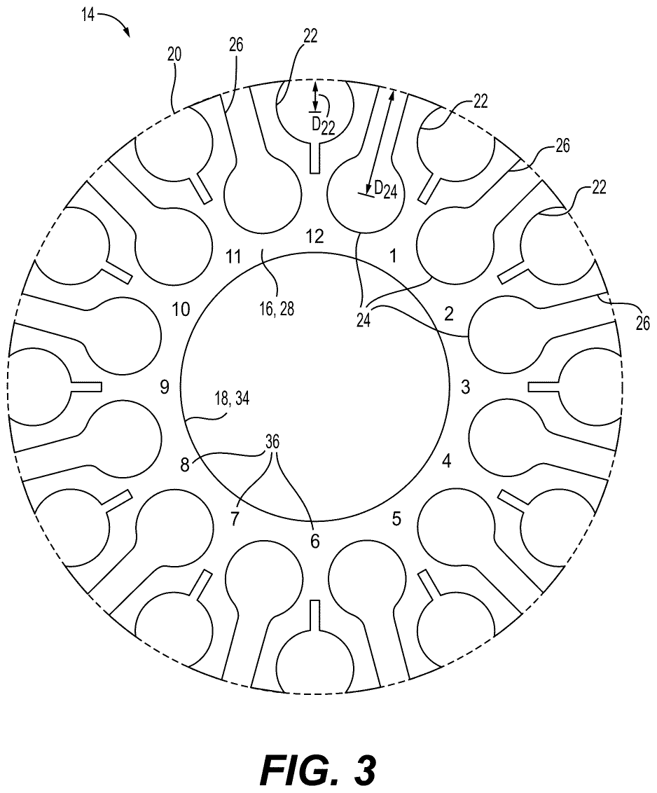

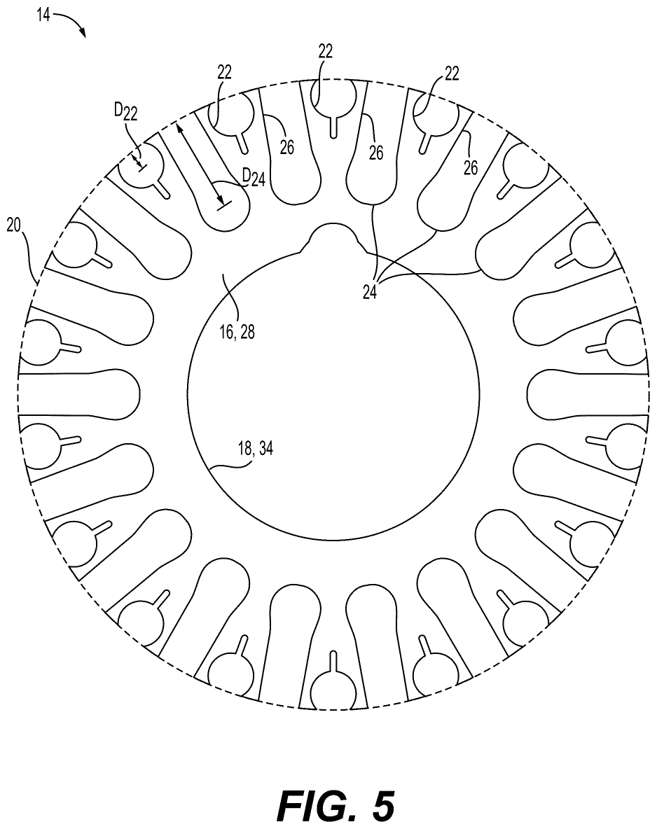

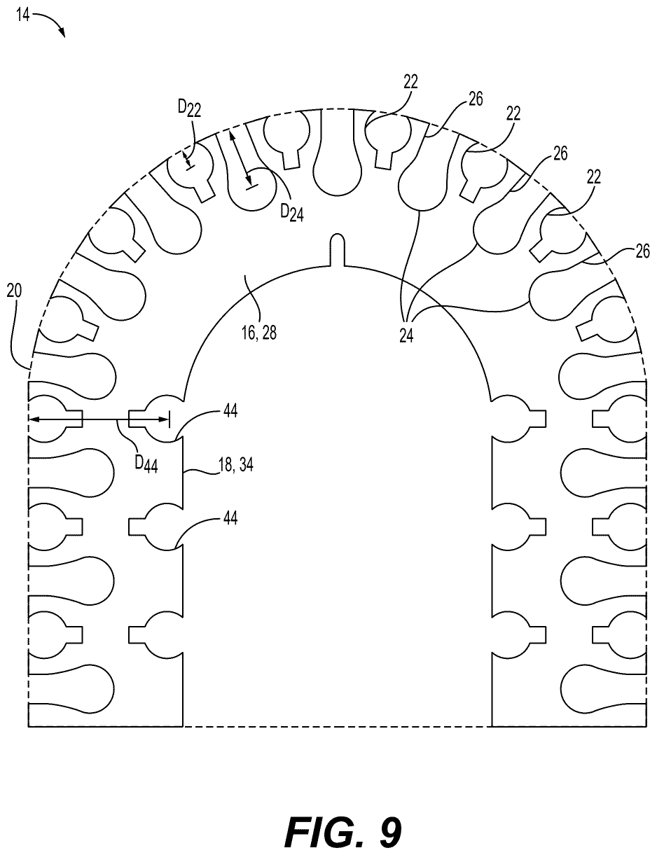

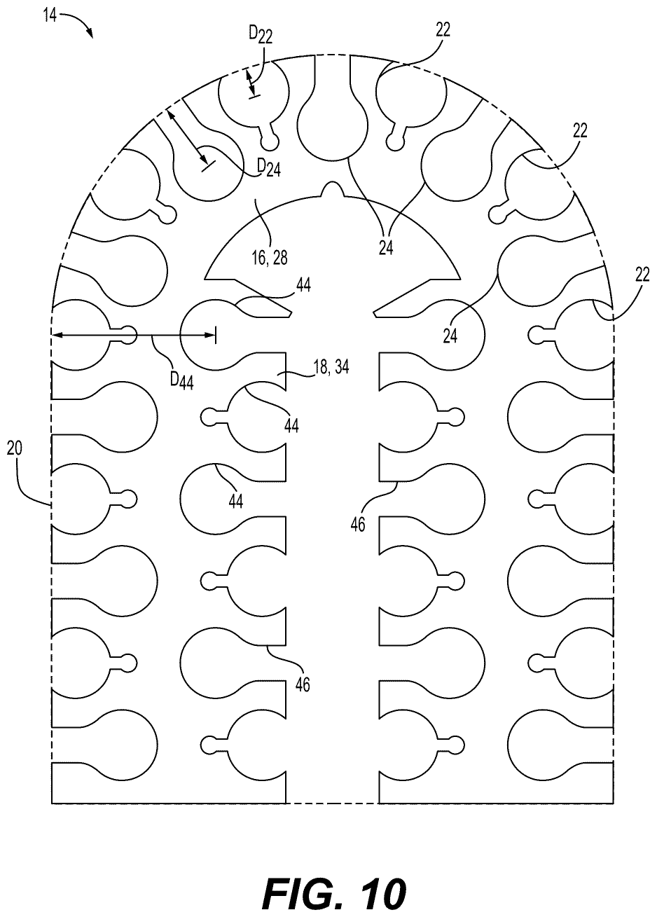

FIGS. 3-10 show various embodiments of a cable organizer 14 for at least one cable 4. The cable organizer 14 may include a support structure 16 having a support structure inner periphery 18 and a support structure outer periphery 20. Periphery in the sense of the present application means an imaginary boundary of the support structure 16, and may be cither an inner periphery at an inner side of the support structure 16 or an outer periphery at an outer side of the support structure 16, for example. As such, both the support structure inner periphery 18 and support structure outer periphery 20 are typically shown in FIGS. 3-10 in dashed lines to indicate that the support structure inner periphery 18 and support structure outer periphery 20 are not physical barriers.

The support structure 16 may include at least one of at least one first cable accommodation guide 22 and at least one second cable accommodation guide 24, each of which may accommodate a cable 4. The at least one first cable accommodation guide 22 may include a plurality of first cable accommodation guides 22, such as from twelve to eighteen first cable accommodation guides 22. Similarly, the at least one second cable accommodation guide 24 may include a plurality of second cable accommodation guides 24, such as from twelve to eighteen second cable accommodation guides 24. Other numbers of first cable accommodation guides 22 and second cable accommodation guide 24 are contemplated and within the scope of the present application.

Each first cable accommodation guide 22 is disposed at a first distance D₂₂ from the support structure outer periphery 20. The first distance De may be measured from the support structure outer periphery 20 to an approximate center of a given first cable accommodation guide 22.

Each second cable accommodation guide 24 is disposed at a second distance D₂₄ from the support structure outer periphery 20. The second distance D₂₄ may be measured from the support structure outer periphery 20 to an approximate center of a given second cable accommodation guide 24. The second distance D₂₄ is different than the first distance D₂₂. For example, the second distance D₂₄ may be greater than the first distance D₂₂.

Each at least one first cable accommodation guide 22 is open with respect to the support structure outer periphery 20 so as to allow a cable 4 to be disposed in the first cable accommodation guide 22. Open in the sense of the present application means that there is no physical boundary on the support structure outer periphery 20 for at least part of the first cable accommodation guide 22. For example, due to a flexible nature of support structure 16, a cable 4 may be disposed adjacent a first cable accommodation guide 22, then pushed toward the first cable accommodation guide 22, resulting in a flexing of the support structure in a vicinity of the first cable accommodation guide 22 that allows the cable 4 to pass into the first cable accommodation guide 22. The cable 4 may then be held in the first cable accommodation guide 22 (e.g., by a tolerance fit).

Each at least one second cable accommodation guide 24 has a different geometry than each at least one first cable accommodation guide 22. For example, each at least one second cable accommodation guide 24 may be open with respect to the support structure outer periphery 20 via an exterior cable passage guide 26 so as to allow the at least one cable 4 to pass through the exterior cable passage guide 26 and be disposed in the at least one second cable accommodation guide 24. Open in the sense of the present application means that there is no physical boundary on the support structure outer periphery 20 for at least part of the second cable accommodation guide 24, including its exterior cable passage guide 26. For example, due to a flexible nature of support structure 16, a cable 4 may be disposed adjacent an exterior cable passage guide 26 of a second cable accommodation guide 24, then pushed toward the second cable accommodation guide 24, resulting in a flexing of the support structure in a vicinity of the second cable accommodation guide 24 that allows the cable 4 to pass into the second cable accommodation guide 42. The cable 4 may then be held in the second cable accommodation guide 24 (e.g., by a tolerance fit). The presence of the exterior cable passage guide 26 in the second cable accommodation guide 24 results in the second distance D₂₄ being different than the first distance D₂₂.

In an embodiment, the cable organizer 14 may include a flexible, conductive covering 28 disposed on the support structure 16. The flexible, conductive covering 28 may be made of an electrically-conductive material, such as EPDM, to facilitate electrical grounding of the cable organizer 14. In an embodiment, the flexible, conductive covering 28 may envelop the support structure 16 (e.g., by overmolding the flexible, conductive covering 28 on the support structure 16 so as to completely cover a material of the support structure 26).

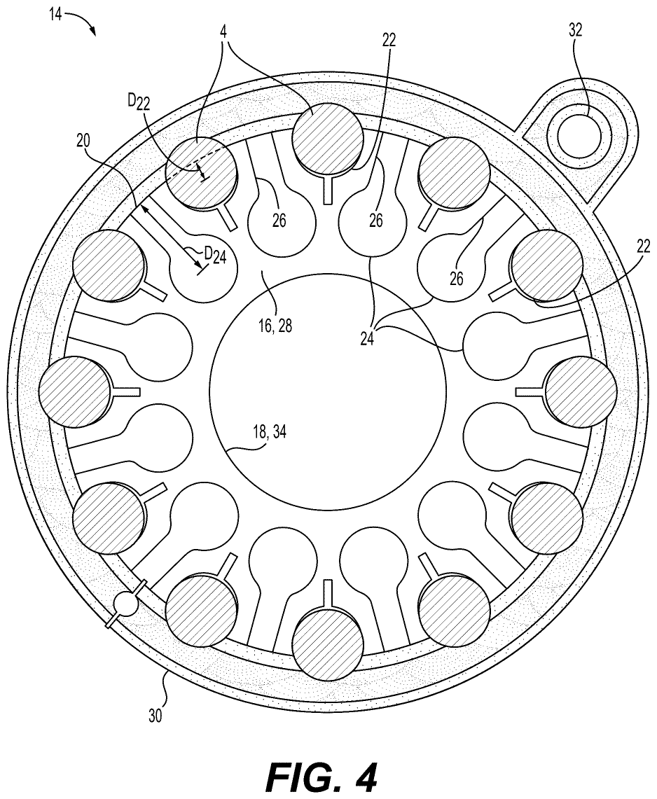

In an embodiment, the cable organizer 14 may include a lock ring 30, as shown in FIG. 4. The lock ring 30 may lock into place a cable inserted into a first cable accommodation guide 22 and/or a second cable accommodation guide 24. More specifically, the lock ring 30 may be locked into place around the support structure outer periphery 20 such that a cable 4 may not be removed from a first cable accommodation guide 22 and/or a second cable accommodation guide 24 unless the lock ring 30 is loosened or removed from the cable organizer 14. In an embodiment, the lock ring 30 may include a ground post mount 32 for electrically grounding the cable organizer (e.g., to allow the cable organizer to be physically attached to a ground post 6, a first support member 8, and/or second support member 12 to facilitate the electrical grounding).

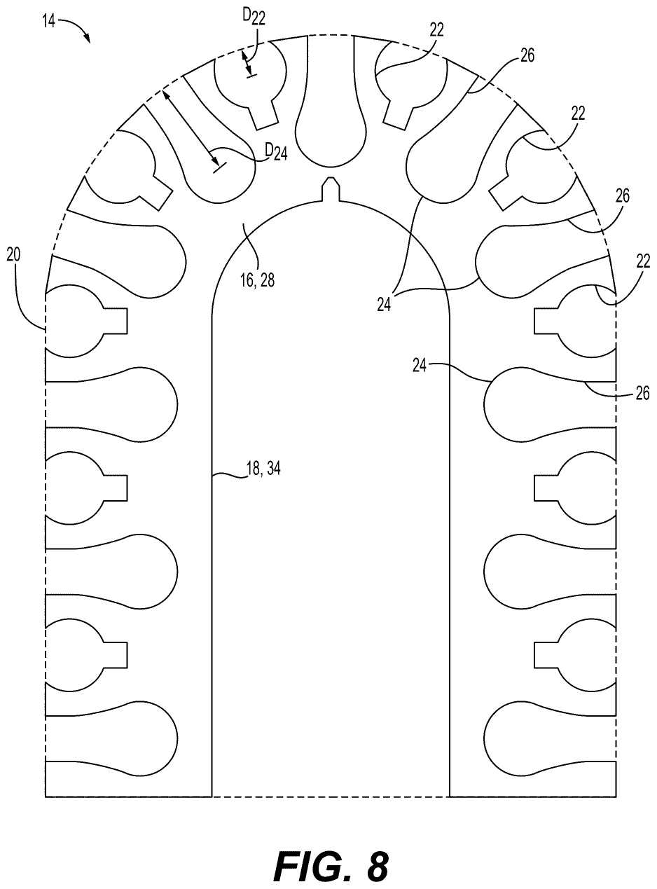

In embodiments, the cable organizer 14 may be circle-shaped, as shown in FIGS. 3-7. In embodiment, the cable organizer 14 may be U-shaped, as shown in FIGS. 8-10. Other shapes of the cable organizer 14 are contemplated and within the scope of the present application.

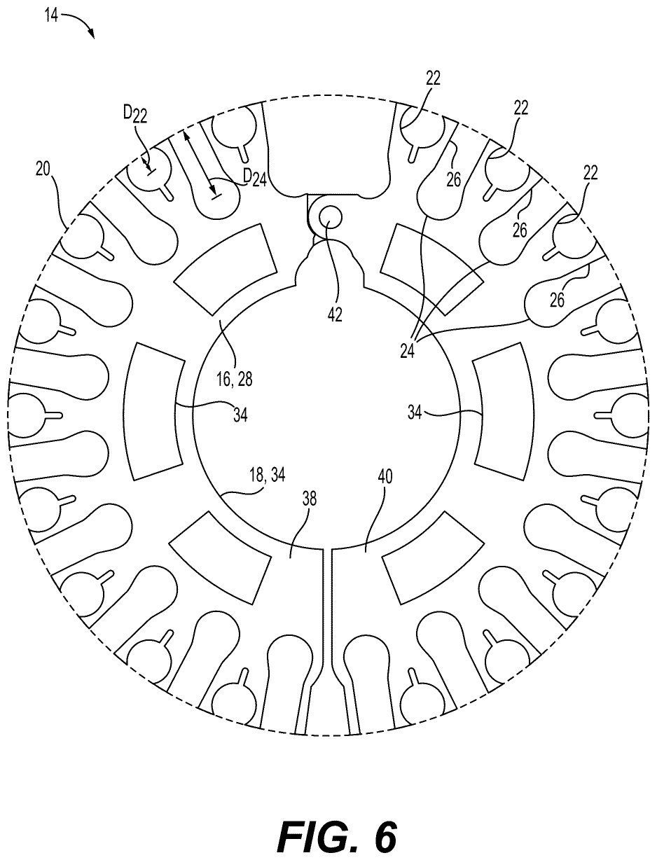

In an embodiment, the support structure inner periphery 18 at least in part defines a structural passage 34 configured to accommodate a support member (e.g., first support member 8) configured to support a weight W₄ of the at least one cable 4. More particularly the support member may pass through the structural passage 34 so as to support the cable organizer 14. Different configurations of structural passage 34 are contemplated and within the scope of the present application, such as structural passages 34 shown in FIG. 6.

In an embodiment, each first cable accommodation guide 22 and/or each second cable accommodation guide 24 may be associated with a different marking 36, as shown in FIG. 3. The different markings 36 (e.g., numbers one through twelve) allow a person handling cables 4 attached to a first cable organizer 14 at a first position to attach those cables 4 in the same manner to a second cable organizer 14 at a second position different than the first position. For example, a first cable 4 could be placed in a cable accommodation guide 22, 24 of a first cable organizer 14 associated with a particular marking 36 (e.g., “7”), and also in a cable accommodation guide 22, 24 of a second cable organizer 14 associated with the same marking 36 (i.e., “7”). Such an arrangement facilitates a logical place of cables 4 across multiple cable organizers 14.

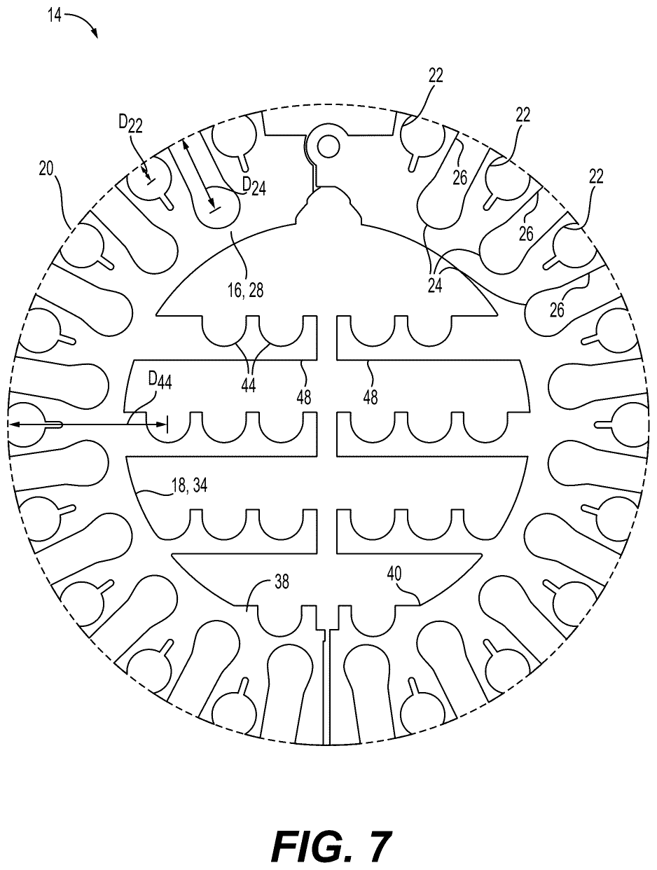

In embodiments, the cable organizer 14 may include a first support structure part 38 and a second support structure part 40, as shown in FIGS. 6-7. The cable organizer 14 may also include a hinge 42 connecting the first support structure part 38 to the second support structure part 40. The hinge 42 allows a relative movement (e.g., a rotation) of the first support structure part 38 with respect to the second support structure part 40. In this configuration, the cable organizer 14 may be opened by moving the first support structure part 38 with respect to the second support structure part 40, positioned around a support member (e.g., first support member 8), then closed by moving the first support structure part 38 toward the second support structure part 40 so as to enclose the support member (e.g., within structural passage 34).

In embodiments, the support structure 16 of the cable organizer 14 may have has at least one third cable accommodation guide 44, as shown FIGS. 7 and 9-10. Each third cable accommodation guide 44 is disposed at a third distance D₄₄ from the support structure outer periphery 20. The third distance D₄₄ is different than the first distance D₂₂ and the second distance D₂₄. For example, the third distance D₄₄ may be greater than the first distance D₂₂ and the second distance D₂₄.

Each third cable accommodation guide 44 may be at least one of: open with respect to the support structure inner periphery 18 so as to allow one cable 4 to be disposed in each third cable accommodation guide 44, and open with respect to the support structure inner periphery 18 via an interior cable passage guide 46 so as to allow one cable 4 to pass through the interior cable passage guide 46 and be disposed in each third cable accommodation guide 44.

In embodiment, the cable organizer 14 may include at least one cable rack 48 disposed on the support structure inner periphery 18, as shown in FIG. 7. Each cable rack may hold a cable 4, such that the cable organizer 14 is capable of holding more cables 4 than an otherwise similar cable organizer 14 without one or more cable racks 48. The one or more cable racks 48 may be disposed in a structural passage 34 defined by the support structure inner periphery 18.

A method of holding at least one cable 4 may include providing a cable organizer, such as cable organizer 14. The cable organizer may include a support structure 16 having a support structure inner periphery 18 and a support structure outer periphery 20. The support structure 16 may also include at least one of: at least one first cable accommodation guide 22 and at least one second cable accommodation guide 24.

The at least one first cable accommodation guide 22 may be disposed at a first distance D₂₂ from the support structure outer periphery 20. The at least one first cable accommodation guide 22 may also be open with respect to the support structure outer periphery 20.

The at least one second cable accommodation guide 24 may be disposed at a second distance D₂₄ from the support structure outer periphery 20. The second distance D₂₄ is different than the first distance D₂₂. For example, the second distance D₂₄ may be greater than the first distance D₂₂. The at least one second cable accommodation guide 24 is open with respect to the support structure outer periphery 20 via an exterior cable passage guide 26.

The method may also include disposing a cable 4 in at least one of: the at least one first cable accommodation guide 22, and the at least one second cable accommodation guide 24. Disposing a cable 4 in the at least one second cable accommodation guide 24 may include passing the cable 4 through the exterior cable passage guide 26 of the second cable accommodation guide 24.

The at least one first cable accommodation guide 22 may include a plurality of first cable accommodation guides 22, such as from twelve to eighteen first cable accommodation guides 22. Similarly, the at least one second cable accommodation guide 24 may include a plurality of second cable accommodation guides 24, such as from twelve to eighteen second cable accommodation guides 24. Other numbers of first cable accommodation guides 22 and second cable accommodation guide 24 are contemplated and within the scope of the present application.

The cable organizer 14 provided in the method may include a flexible, conductive covering 28 disposed on the support structure 16. The flexible, conductive covering 28 may be made of an electrically-conductive material, such as EPDM, to facilitate electrical grounding of the cable organizer 14. In an embodiment, the flexible, conductive covering 28 may envelop the support structure 16 (e.g., by overmolding the flexible, conductive covering 28 on the support structure 16 so as to completely cover a material of the support structure 26).

In embodiments, the cable organizer 14 may be circle-shaped, as shown in FIGS. 3-7. In embodiment, the cable organizer 14 may be U-shaped, as shown in FIGS. 8-10. Other shapes of the cable organizer 14 are contemplated and within the scope of the present application.

The method may also include disposing the cable organizer 14 on at least one of a ground post 6, a first support member 8, and/or second support member 12 so as to support a weight W₄ of the cables 4 of the cable organizer 14 above a ground surface and/or electrically ground the cables 4.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

2 prior art cable organizer
4 cable
6 ground post
8 first support member
10 support platform
12 second support member
14 cable organizer
16 support structure
18 support structure inner periphery
20 support structure outer periphery
22 first cable accommodation guide
24 second cable accommodation guide
26 exterior cable passage guide
28 flexible, conductive covering
30 lock ring
32 ground post mount
34 structural passage
36 marking
38 first support structure part
40 second support structure part
42 hinge
44 third cable accommodation guide
46 interior cable passage guide
48 cable rack
D₂₂ first distance
D₂₄ second distance
W₄ weight of cable
D₄₄ third distance

What is claimed is:

1. A cable organizer for at least one cable, the cable organizer comprising:
a support structure having a support structure inner periphery and a support structure outer periphery,
wherein the support structure has at least one of:
at least one first cable accommodation guide disposed at a first distance from the support structure outer periphery, the at least one first cable accommodation guide being open with respect to the support structure outer periphery so as to allow the at least one cable to be disposed in the at least one first cable accommodation guide, and
at least one second cable accommodation guide disposed at a second distance from the support structure outer periphery, the second distance being different than the first distance, the at least one second cable accommodation guide being open with respect to the support structure outer periphery via an exterior cable passage guide so as to allow the at least one cable to pass through the exterior cable passage guide and be disposed in the at least one second cable accommodation guide.

2. The cable organizer of claim 1, wherein the at least one first cable accommodation guide comprises from twelve to eighteen first cable accommodation guides.

3. The cable organizer of claim 1, wherein the second distance is greater than the first distance.

4. The cable organizer of claim 3, wherein the at least one second cable accommodation guide comprises from twelve to eighteen second cable accommodation guides.

5. The cable organizer of claim 1, further comprising:
a flexible, conductive covering disposed on the support structure.

6. The cable organizer of claim 5, wherein the flexible, conductive covering envelopes the support structure.

7. The cable organizer of claim 1, further comprising:
a lock ring configured to lock into place the at least one cable in the at least one first cable accommodation guide.

8. The cable organizer of claim 7, wherein the lock ring comprises a ground post mount configured to electrically ground the cable organizer.

9. The cable organizer of claim 1, wherein the support structure is circle-shaped.

10. The cable organizer of claim 1, wherein the support structure is U-shaped.

11. The cable organizer of claim 1, wherein the support structure inner periphery at least in part defines a structural passage configured to accommodate a support member configured to support a weight of the at least one cable.

12. The cable organizer of claim 1, wherein each first cable accommodation guide of the at least one first cable accommodation guide or each second cable accommodation guide of the at least one second cable accommodation guide is associated with a different marking.

13. The cable organizer of claim 1, wherein the cable support structure comprises a first support structure part and a second support structure part, and
wherein the cable organizer further comprises a hinge connecting the first support structure part to the second support structure part, the hinge being configured so as to allow a relative movement of the first support structure part with respect to the second support structure part.

14. The cable organizer of claim 1, wherein the support structure has at least one third cable accommodation guide disposed at a third distance from the support structure outer periphery, the third distance being greater than the first distance and the second distance, the at least one third cable accommodation guide being at least one of:
open with respect to the support structure inner periphery so as to allow the at least one cable to be disposed in the at least one third cable accommodation guide, and
open with respect to the support structure inner periphery via an interior cable passage guide so as to allow the at least one cable to pass through the interior cable passage guide and be disposed in the at least one third cable accommodation guide.

15. The cable organizer of claim 1, further comprising:
at least one cable rack disposed on the support structure inner periphery, the at least one cable rack being configured to hold the at least one cable.

16. A method of holding at least one cable, the method comprising:
providing a cable organizer, the cable organizer comprising a support structure having a support structure inner periphery, a support structure outer periphery, and at least one of:
at least one first cable accommodation guide disposed at a first distance from the support structure outer periphery, the at least one first cable accommodation guide being open with respect to the support structure outer periphery, and
at least one second cable accommodation guide disposed at a second distance from the support structure outer periphery, the second distance being different than the first distance, the at least one second cable accommodation guide being open with respect to the support structure outer periphery via an exterior cable passage guide; and
disposing the at least one cable in at least one of:
the at least one first cable accommodation guide, and
the at least one second cable accommodation guide by passing the at least one cable through the exterior cable passage guide.

17. The method of claim 16, wherein the at least one first cable accommodation guide comprises from twelve to eighteen first cable accommodation guides, and
wherein the at least one second cable accommodation guide comprises from twelve to eighteen second cable accommodation guides.

18. The method of claim 16, wherein the cable organizer comprises a flexible, conductive covering disposed on the support structure, the flexible, conductive covering enveloping the support structure.

19. The method of claim 16, wherein the support structure is circle-shaped or U-shaped.

20. The method of claim 16, further comprising:
disposing the cable organizer on a support member so as to support a weight of the at least one cable above a ground surface.
